(19) United States
(12) Patent Application Publication
(10) Pub. No.: US 2012/0228088 A1
(43) Pub. Date: Sep. 13, 2012

(54) Continuous-Wire Transport Conveyor for Food Dehydration

(76) Inventor: Nolton C. Johnson, JR., Bend, OR (US)

(21) Appl. No.: 13/416,653

(22) Filed: Mar. 9, 2012

Related U.S. Application Data
(60) Provisional application No. 61/450,978, filed on Mar. 9, 2011.

(51) Int. Cl. B65G 15/10; B65G 23/44; B65G 45/10

(52) U.S. Cl. 198/494; 198/817; 198/813

(57) ABSTRACT

A conveying surface operating in a fashion of a conveying belt. The surface is formed to provide movement of material on the surface between two rollers. The conveying surface is formed by a continuous wire stretching in individual substantially parallel strands, between spiraled communications around the first roller and second roller. Spacing of the individual parallel strands of wire yields uninterrupted gaps for airflow therethrough and tensioning of the wire between the rollers eliminates sagging. The surface may be cleaned while moving by cleaning a return section of the wire strand between the rollers.

This application claims priority to U.S. Provisional Patent Application Ser. No. 61/450,978 filed on Mar. 9, 2011, and incorporated herein in its entirety by this reference.

### BACKGROUND OF THE INVENTION

1. Field of the Invention

The present invention relates to transport conveyors and more particularly to a transport conveyor for drying and/or dehydrating food such as fruits and vegetables. The device operates to convey food through the process using a conveying surface composed of a single endless wire running in a continuous looping fashion and improves significantly on the air passage to the food during the process.

2. Prior Art

A food dehydrator is an apparatus which removes moisture from food to aid in its preservation. Generally, a food dehydrator uses heat and air flow past the food being dehydrated to remove and thereby reduce the water content of foods. The water content of most food is usually very high, typically 80% to 95% for various fruits and vegetables and 50% to 75% for various meats. Removing moisture from food restrains various bacteria from growing and spoiling food so as to allow longer storage for later consumption. Further, removing moisture from food dramatically reduces the weight of the food. Thus, food dehydrators are used to preserve and extend the shelf life of various foods.

Conventionally, a food dehydrator employs a heating element, a fan, and air vents allowing for air circulation past the food being treated. The food is treated while positioned on racks, screens, or food trays during the process. A dehydrator's heating element moves drying air using fans and vents to communicate the drying air to the food which is positioned upon the racks and screens to remove moisture from food.

Conveyor style dehydrators employ a moving screen of a chain style mesh fabric on which food is placed. As the conveyor moves, the dehydrator's heating element warms air which moves past or around the food causing its moisture to be released from the interior of the food. A fan concurrently blows the warm, moist air out of the dehydrator using ducting or air vents. This process continues for hours or until the food is dried to a substantially lower water content, usually fifteen to twenty percent or less by weight.

Unfortunately, such conventional conveyors using woven or knitted style mesh tend to collect food parts during the process which causes clogged gaps between the wire mesh forming the moving screen. Additionally, because the belt is formed of screen like material or fabric such as a mesh, tensioning the formed belt is very had to accomplish. This is because of the interwoven threads or yarn, are not easily evenly tensioned since the individual threads forming the weave or mesh do not communicate tension evenly to the side edges and ends of the formed belt. If the woven or knitted mesh material is stretched too tightly, in an effort to flatten it out under the weight of carried food, it can easily become over taught causing rips to form in the formed belt thereby damaging or destroying it.

As a consequence of the inherent problem with tensioning woven or knitted or otherwise meshed belt materials, and the trade off of over-tensioning versus the potential for damage to the belt, such belts tend to sag under the weight of food placed thereon. They also sag if the weight of the food thereon is not evenly positioned to evenly distribute the aggregate weight thereof. Further, because of the constant sagging and uneven tension, over time as the formed mesh of the belt stretches from use.

Since the belt is essentially formed of interwoven fibers or wires, a stretching of portions thereof causes the loosening of the mesh belt during rotation and formed cavities in the planar surface where food collects or is drawn. Further the interwoven mesh employs many fibers and/or wires which inherently collect parts from the food placed thereon. This causes clogged gaps between the mesh fibers or wires which lessens the airflow through the belt, inhibiting drying of the food. Further, food collecting in the gaps between woven wires and fiber, attracts bacteria and other pathogens which see the material as an easy meal and can contaminate subsequent food placed on the mesh belt. This combination of problems tend to make conventional belt dehydrators a maintenance nightmare and also can turn into a severe problem due to mold and bacteria which can grow in the food particles left behind in the gaps.

Further, in many industries, goods are transported across a conveyor through a controlled environment for washing, drying, sanitizing, painting, coating, and other processes. Also, goods may simply be transported across ambient conditions for air drying or for the sole purpose of transport. Such an example is the food industry for cleaning then drying fruit. U.S. Pat. No. 4,291,472 to Lewis teaches a drying apparatus where a conveying belt transports articles such as fruit, through a controlled environment for drying the articles. The conveying means belt as a continuous surface in a loop, depositing articles at one end before looping back.

Construction of such conveying systems has seen some technological advancement in the field of wire and link conveyors such as found in U.S. Pat. No. 5,810,159 to Dorpmund. Dorpmund teaches a conveying surface comprised of a plurality of hinged and woven wires and link elements that provide air permeability through the gaps in the wire formed wire mesh that is desirable for drying as well as many other purposes. However, as noted above, the small gaps and the formed thick mesh belt, still invite food particles to stay behind and clog the mesh and grow bacteria.

U.S. Pat. Nos. 3,920,117, 4,953,693, 5,404,998, and 5,934,448 similarly teach conveyors with linked or interlocked elements to form a mesh like belt. The interlocking and linking nature of the modular elements of the above and many other prior art conveyors lead to increased wear since elements must rotate relative to adjacent elements during turns, curves, or bends in the conveying surface. Such wear may lead to the dispersion of fine particles from rubbing surfaces. In the case of food or consumable produce conveyance, such wear can have catastrophic repercussions.

Furthermore, such interlocked and linked devices can be difficult to clean or sanitize as is often regularly desired in food and consumable product conveyance due to the complexity and number of individual components. The shear number of components also leads to difficulties in repair or replacement for one or a few of such components.

As such there is a continuing and unmet need for a transport conveyor or conveying surface that may be employed for dehydrating food, and for other conveying processes to which it is adaptable, which provides maximum airflow through the conveying surface and to the suspended food. Such a device should eliminate the interwoven warp and fill formed mesh or woven belt which inhibits proper even tensioning and which holds food particles and harbors bacteria and renders the device hard to clean.

Still further, such a device should support a maximum of food weight without the need for a woven mesh and should eliminate the uneven surfaces caused by belts which must be tensioned in two directions for even surfacing but cannot. Finally, such a device should yield a conveying belt that can be made continuously self-cleaning and can be easily and continually tensioned or tension-adjusted to maximize the planar and even support capabilities thereof. Finally, such a device should be composed of a limited number of relative moving parts to increase liability and be easily cleaned and sanitized.

### SUMMARY OF THE INVENTION

The device herein disclosed and described provides a solution for the above noted shortcomings in prior art through the provision of a planar formed moving belt for food dehydration and other conveying purposes requiring a substantially planar moving surface. The formed conveying surface of the device herein is not woven or formed of interlocked wires or threads and therefor does not suffer from the aforementioned pitfalls of a woven or knitted multi-layer belt.

Instead, the moving conveyor surface of the disclosed device maximizes space for airflow past supported food or other material, between large parallel gaps between a single wire or cable which is continuously wrapped around grooved supporting rollers to maintain the wire in parallel strands abutting large air gaps. Movement of the surface is simple and provided by two rotating drums.

In operation, the drums are spaced apart at a distance required by the specific conveyance surface and the material thereon to achieve the planar surface required. With each successive wrap around a grooved drum, the cable or wire is spaced further along the length of the respective drums eliminating the need for woven or crossed successive extending strands. The gaps between each strand of wire are totally uninterrupted between the two rollers thereby maximizing airflow between the parallel strands forming the moving belt or conveyor surface.

In a particularly preferred mode of the device, the cable or wire is made ‘endless’. As the wire or cable extends off of the side end of one drum, it is directed back to the opposing side end of the opposing rotating drum from which it originally exited, by means of pulleys or similar cabling systems.

The distance of cable to cable (or wire to wire) parallel spacing, forming the width of elongated uninterrupted air gaps running the distance between the two rollers, can be selectively adapted to a specific nominal width depending on the conveying article. For example, half the width of a cherry for the conveyance of dried pitted cherries through the device thereby maximizing airflow to the supported cherry since only one wire essentially blocks airflow and two large uninterrupted gaps provide airflow.

Grooves formed into both drums provide a means to register each wrapped portion of the single wire and maintain it in the desired spacing forming parallel wires and formed gaps of desired widths to maximize airflow. Alternatively, a means to maintain spacing of cable or wire around the driving drums, can be accomplished by smooth drums with a grooved guide bar positioned in lead of the oncoming cable or wire, or a combination of grooved drums and the above noted spacing means.

Additionally provided is a means to maintain a desired tension on the entire system and all of the parallel strands of the single wire forming the belt. This is done by biasing or translating the drums or rollers closer or further apart as the case may be. It must also be noted that intermediate rollers can be employed for appreciably long transport distances to provide support for the weight on the moving surface of the parallel wires.

The system thus provides a means to form an extremely strong support belt for food in a single layer, with no weaving or knitting, and with maximized uninterrupted gaps between the parallel wires for airflow. The single wire forming the belt does not retain food as conventional belts do, and can be continually washed in real time as the single wire moves in positions where no food will encounter the washing until it dries.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of the invention to provide a conveyor surface comprised of a single endless cable, wire, or monofilament wire.

It is a further object of the invention to direct the pay off of the wire or cable from the pay off end to the feeding end by means of a pulley system.

A further object of the invention is the provision of a tensioning means to maintain a specific tension on the wire or cable as desired.

It is another object of the invention to provide a monofilament or cable conveyor where the spacing between adjacent extending strands can be selectively adjusted to maximize the uninterrupted gaps for airflow.

It is a further object of the invention to eliminate the collection of food and germs and pathogens found in woven or intertwined belts, by using a single wire which may be continuously cleaned in real time.

### BRIEF DESCRIPTION OF DRAWING FIGURES

FIG. 1 shows a top schematic view of the frame and tensioned rollers of the present invention without the single continuous wire element engaged.

FIG. 2 is a top view of a device of FIG. 1 showing the single wire element employed for movement of food during the dehydration or drying process.

FIG. 3 shows a side view of the tensioning components of the disclosed device depicting the driving element and tensioning components.

FIG. 4 depicts a perspective labeled view of the device showing the single wire system and return pulleys below the conveyor belt formed by the single tensioned wire.

FIG. 5 shows a labeled side view of the device of FIG. 3 and showing a means to rotate the rollers using an air or electric driven cylinder or an electric motor and showing the tensioning means.

FIG. 6 shows a bottom perspective view of the device labeled to show the various components to aid in clarity.

### DETAILED DESCRIPTION OF THE PREFERRED EMBODIMENTS OF THE INVENTION

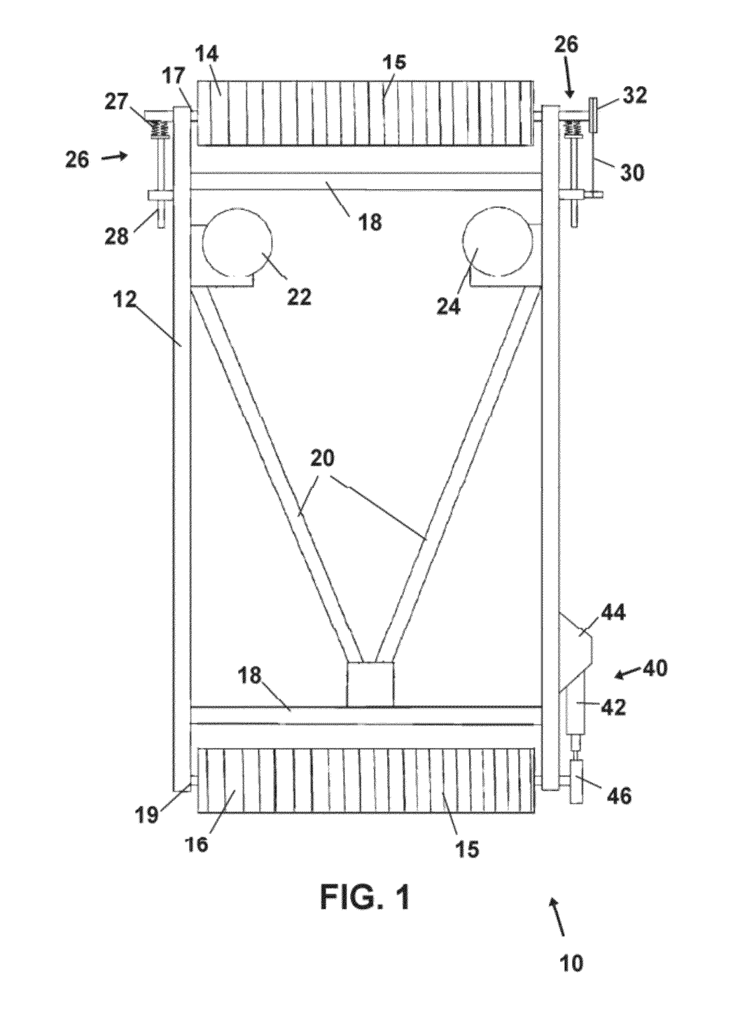

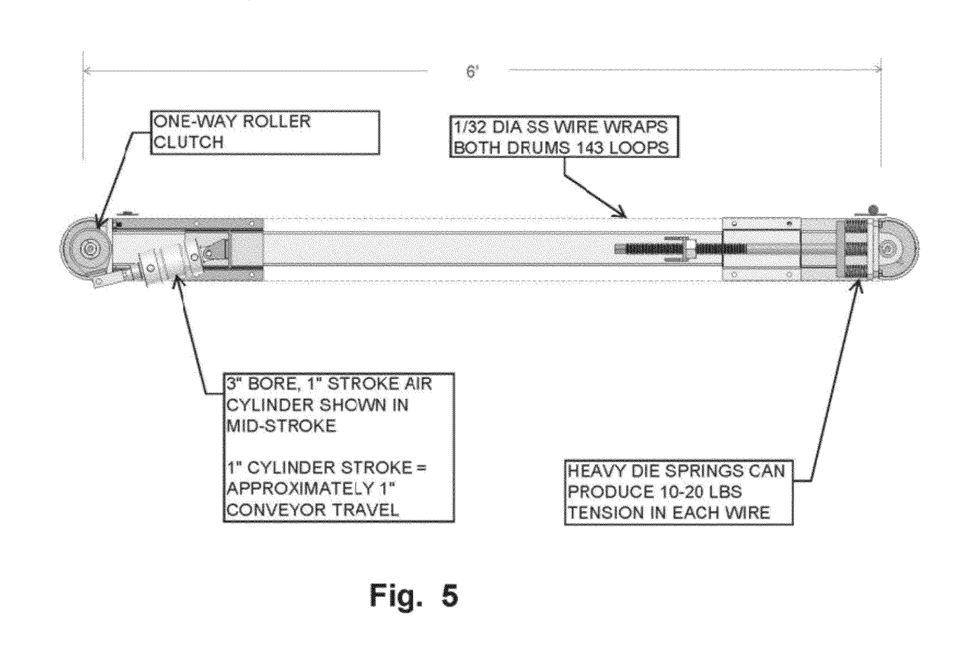

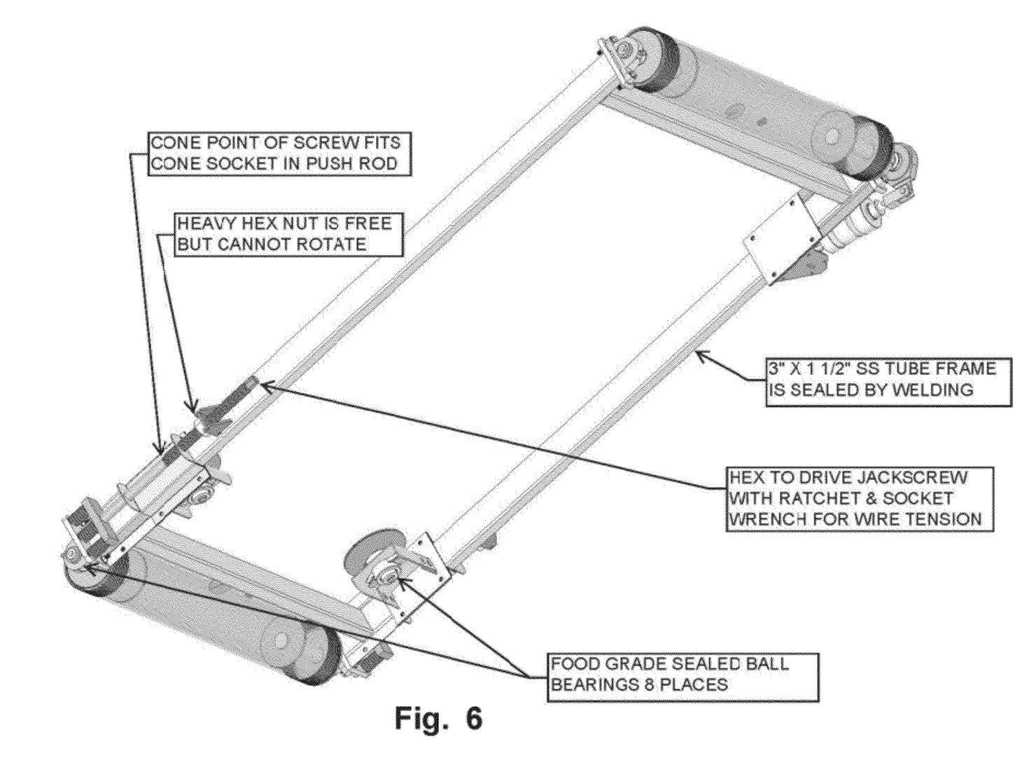

Now referring to drawings in FIGS. 1-6, wherein similar components are identified by like reference numerals, there is seen in FIG. 1 a top view of the frame 12 of the device 10 where the single strand of wire 48 forming the conveyor surface is removed for clarity. It should be noted that the use of the word “wire” is to mean any single strand or multi-strand metal or textile thread, cable, or wire, capable of tensioned engagement in the device 10 herein and in no manner should it be limiting.

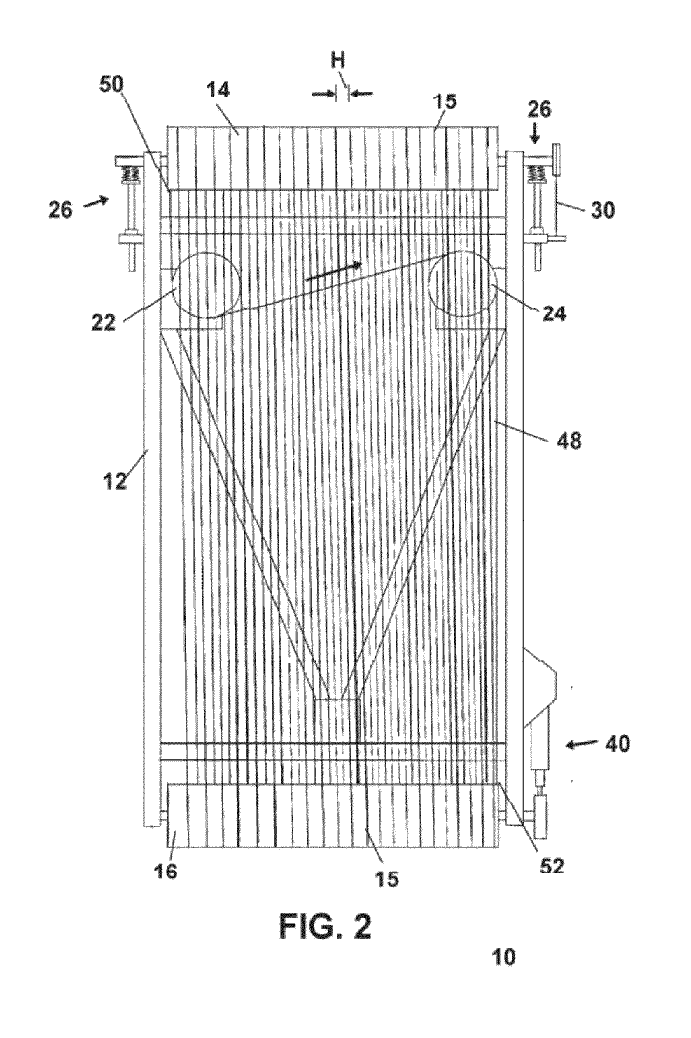

First rotating drum 14 and second rotating drum 16 rotating drums are rotatably engaged to the frame 12 at axles 17 and 19 respectively. Means to register and maintain the positions and spacing of the wire around the drums are shown as guide grooves 15 formed into the surface of the drums 14,16. However, it is envisioned that other means to maintain the spacing of the wires during ingress and egress from the drums 14 and 16, can be employed, such as a grooved bar inline with the incoming and outgoing wire 48 at the top and bottom of the drums 14 and 16, and any such means to maintain the spacing of the wire 48 during ingress to, around, and egress from, the drums 14 and 16 as would occur to those skilled in the art and provides a means to register the positions of the wires relative to each drum and to track the wire around the drum as in FIG. 2, and maintains a consistent wire to wire parallel spacing, is considered within the scope of this application and patent.

Structural support of the frame 12 is provided by cross elements 18 and 20. Support elements 20 further provide a means to rotatably engage a first 22 and second 24 direction pulleys whose purpose will be detailed shortly.

In use it is important to maintain consistent or specific tension in the strands of wire 48 or cable being employed and held between the drums. This tensioning is provided through the provision of the tensioning system 26 shown in FIG. 1-3 and employs spring elements 27 which are engaged to the axle 17 where tensioning adjustments can be made by adjustment screw 28. A reference wire 30 is used to selectively obtain the desired tension and is engaged to axle 17 at pulley 32. Other means to maintain a measured and desired tension by positioning the axis of the two drums closer and further from each other may be employed and is anticipated within the scope of this application.

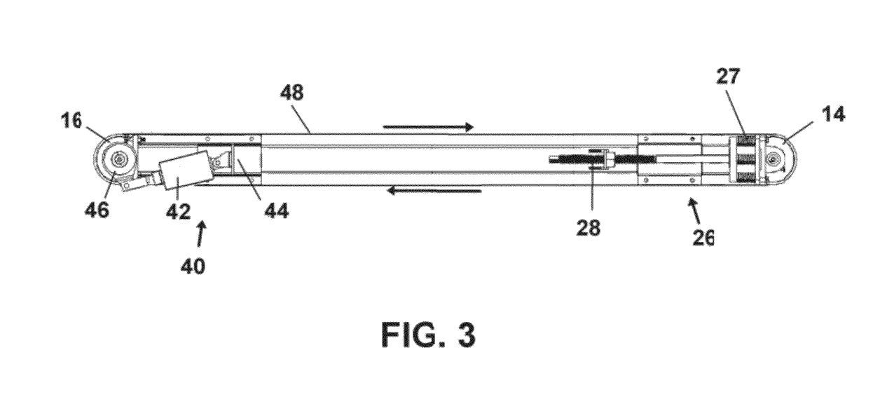

The drive system 40 as best seen in FIG. 3, currently employs means to rotate at least one of the rollers such as an electric or air driven motor, or other such means as would occur to those skilled in the art. Currently the drive system is comprised of a stroke air cylinder 42 that is engaged to the frame 12 at bracket 44. The air cylinder 42 provides a means to drive the second drum 16 in a stepping motion through the provision of a one way roller clutch 46 or ratcheting device which is engaged and co-axially aligned with axle 19 and drum 16. Although other means to rotate the rollers might be used, such as an electric motor.

FIG. 2 shows a similar top view of the device 10 with the continuous wire element 48 engaged in the as-used position. The wire 48 is fed from the feed ‘in’ or ingress position 52 at the second drum 16 and traverses in strands or sections between the drums 14,16 and is wrapped about each respective drum upon each successive traverse of the distance spanned and is guided within grooves 15. The grooves 15 further define the spacing H that is selectively chosen dependent by the transport articles. The grooves 15 are slightly spiraled in their traverse around the drums to communicate the wire 48 from one end to the other. Alternatively, the drums may be smooth while a grooved guide bar may be present at or near the drums to achieve the same purpose of maintaining the spacing of the wire during ingress and egress from the rollers 14 and 16. Therefor, the depictions set forth by the figures in this application should not be considered limiting in the manner that the parallel spacing of the traversing wire is maintained.

As the wire 48 pays off the drum 14 at position 50 it is directed to the first re-direction pulley 22. The second pulley then 24 directs the wire 48 back to the feed ‘in’ position 52 closing the endless loop of the wire 48 between and around both drums 14 and 16.

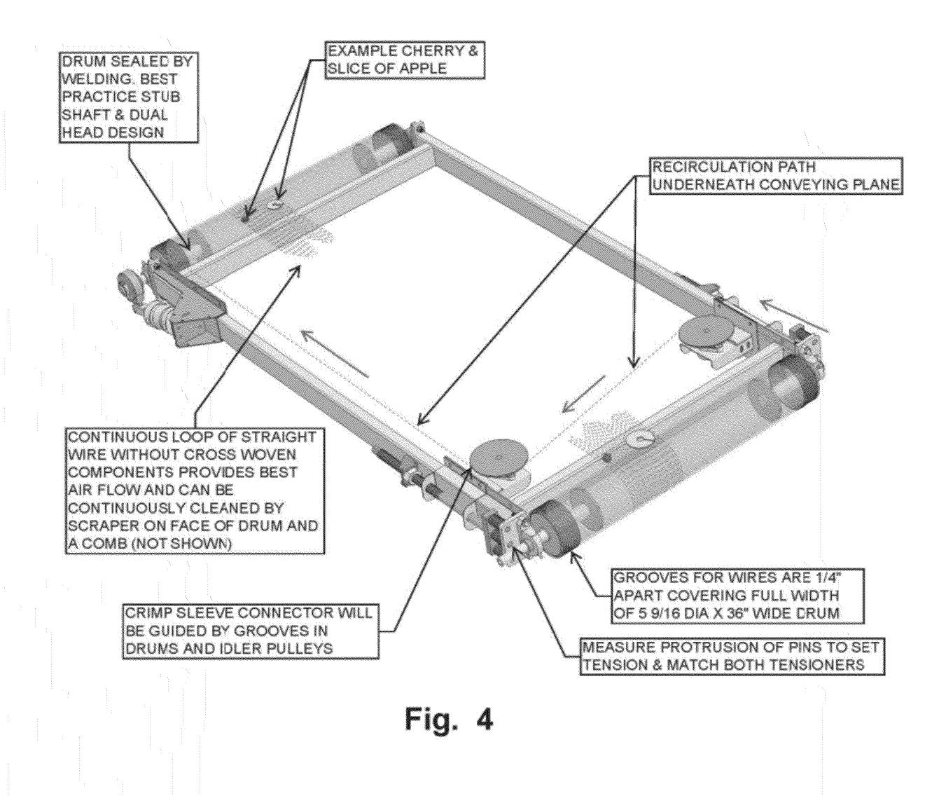

A side view of the device 10 is shown in FIG. 3. Although the reference tension wire 30 of FIG. 2 has been omitted for clarity, a detail of the tensioning system 26 and drive system 40 are shown. Additionally labeled FIGS. 4-6 depict various labeled views of preferred modes and components of the device 10 herein for further clarity.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A conveying surface configured for movement from one end of a conveying apparatus, toward an opposing end thereof, comprising:
a first roller rotationally engaged at a first side with a first support, and rotationally engaged at a second side with a second support;
a second roller positioned a separation distance from said first roller, said second roller rotationally engaged at a first end with a third support and rotationally engaged at a second end with a fourth support;
a continuous wire stretching in individual substantially parallel strands, between said first roller and said second roller;
gaps positioned in-between each of said strands,
said wire communicating at opposing ends of said strands in increments of a respective spiral communication around said first roller and said second roller;
a return strand of said wire communicating from a terminating point of said respective spiral communication around said second roller, to a beginning point of said respective spiral communication around said first roller;
means for powered rotation of one of said rollers; and
said conveying surface defined by upper surfaces of said strands of said wire, said conveying surface moving in a direction of said rotation between said first roller and said second roller.

2. The conveying surface as defined in claim 1, additionally comprising:
means to maintain a spacing of said strands of said wire translating away from one of said rollers and toward a said spiral communication with the other of said rollers, is maintained at a determined distance.

3. The conveying surface as defined in claim 2 wherein said means to maintain a spacing of said strands of said wire comprises:
a respective spiral depression formed in each of said first roller and said second roller; and
individual loops of said spiral depression spaced at said determined distance.

4. The conveying surface as defined in claim 1, additionally comprising:
means for cleaning said return strand of said wire whereby said conveying surface is cleaned and of contaminants from material carried thereon concurrently with the moving of said conveyor surface.

5. The conveying surface as defined in claim 1, additionally comprising:
an aggregate area of all of said gaps being larger than an aggregate area of all of said strands thereby defining a majority of said area occupied by said conveying surface for uninhibited passage of air therethrough.

6. The conveying surface as defined in claim 2, additionally comprising:
an aggregate area of all of said gaps being larger than an aggregate area of all of said strands thereby defining a majority of said area occupied by said conveying surface for uninhibited passage of air therethrough.

7. The conveying surface as defined in claim 3, additionally comprising:
an aggregate area of all of said gaps being larger than an aggregate area of all of said strands thereby defining a majority of said area occupied by said conveying surface for uninhibited passage of air therethrough.

8. The conveying surface as defined in claim 4, additionally comprising:
an aggregate area of all of said gaps being larger than an aggregate area of all of said strands thereby defining a majority of said area occupied by said conveying surface for uninhibited passage of air therethrough.

9. The conveying surface as defined in claim 2, additionally comprising said means to maintain a spacing of said strands of said wire translating away from one of said rollers and toward a said spiral communication with the other of said rollers, is adjustable thereby providing means for adjustment of said gap.

10. The conveying surface as defined in claim 3, additionally comprising adjustment of said determined distance of said spacing of said individual loops of said spiral depression provides a means for adjusting said gap.

11. The conveying surface as defined in claim 10, additionally comprising:
said spacing of said loops being formed to equal 50% or less of a diameter of an article carried by said conveying surface, whereby said article is provided with a gap preventing it from falling between said strands of wire, but maximizing airflow therethrough.

12. The conveying surface as defined in claim 1, additionally comprising:
means to adjust said separation distance and thereby adjusts a tension of said strands of wire communicating between said first roller and said second roller.

13. The conveying surface as defined in claim 2, additionally comprising:
means to adjust said separation distance and thereby adjusts a tension of said strands of wire communicating between said first roller and said second roller.

14. The conveying surface as defined in claim 3, additionally comprising:
means to adjust said separation distance and thereby adjusts a tension of said strands of wire communicating between said first roller and said second roller.

15. The conveying surface as defined in claim 4, additionally comprising:
means to adjust said separation distance and thereby adjusts a tension of said strands of wire communicating between said first roller and said second roller.

16. The conveying surface as defined in claim 5, additionally comprising:
means to adjust said separation distance and thereby adjusts a tension of said strands of wire communicating between said first roller and said second roller.

17. The conveying surface as defined in claim 6, additionally comprising:
means to adjust said separation distance and thereby adjusts a tension of said strands of wire communicating between said first roller and said second roller.

18. The conveying surface as defined in claim 7, additionally comprising:
means to adjust said separation distance and thereby adjusts a tension of said strands of wire communicating between said first roller and said second roller.

19. The conveying surface as defined in claim 9, additionally comprising:
means to adjust said separation distance and thereby adjusts a tension of said strands of wire communicating between said first roller and said second roller.

20. The conveying surface as defined in claim 11, additionally comprising:
means to adjust said separation distance and thereby adjusts a tension of said strands of wire communicating between said first roller and said second roller.
